(19) United States
(12) Patent Application Publication
(10) Pub. No.: US 2006/0254748 A1
(43) Pub. Date: Nov. 16, 2006

(54) Cooling cycle

(75) Inventors: Toshiharu Watanabe, Tochigi (JP); Masahiro Iguchi, Saitama (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/452,222

(22) Filed: Jun. 14, 2006

Related U.S. Application Data
(62) Division of application No. 11/221,986, filed on Sep. 9, 2005.
Application No. 11/221,986 is a division of application No. 10/191,809, filed on Jul. 10, 2002, now abandoned.

(30) Foreign Application Priority Data
Jul. 12, 2001 (JP) 2001-212274
Jul. 2, 2002 (JP) 2002-193065

(51) Int. Cl. B60H 1/00

(52) U.S. Cl. 165/41

(57) ABSTRACT

In a cooling cycle including a compressor, a gas cooler, a throttling device, and an evaporator, a heat exchanger is arranged between the compressor and the throttling device for carrying out heat exchange through a refrigerant compressed by the compressor.

The present application is a divisional of U.S. application Ser. No. 11/221,986, filed Sep. 9, 2005, which is a divisional of U.S. application Ser. No. 10/191,809, filed Jul. 10, 2002, the entire contents of which is incorporated herein by reference.

### BACKGROUND OF THE INVENTION

The present invention relates to a cooling cycle suited for use in automotive air-conditioning systems, and more particularly, to a cooling cycle using supercritical or transcritical refrigerant such as CO₂.

The cooling cycle for automotive air conditioners uses fluorocarbon refrigerant such as CFC12, HFC134a or the like. When released into the atmosphere, fluorocarbon can destroy an ozone layer to cause environmental problems such as global warming. On this account, the cooling cycle has been proposed which uses CO₂, ethylene, ethane, nitrogen oxide or the like in place of fluorocarbon.

The cooling cycle using CO₂ refrigerant, is similar in operating principle to the cooling cycle using fluorocarbon refrigerant except the following. Since the critical temperature of CO₂ is about 31° C., which is remarkably lower than that of fluorocarbon (e.g. 112° C. for CFC12), the temperature of CO₂ in a gas cooler or condenser becomes higher than the critical temperature thereof in the summer months where the outside-air temperature rises, for example, CO₂ does not condense even at the outlet of the gas cooler.

The conditions of the outlet of the gas cooler are determined in accordance with the compressor discharge pressure and the CO₂ temperature at the gas-cooler outlet. And the CO₂ temperature at the gas-cooler outlet is determined in accordance with the heat-radiation capacity of the gas cooler and the outside-air temperature. However, since the outside-air temperature cannot be controlled, the CO₂ temperature at the gas-cooler outlet cannot be controlled practically. On the other hand, since the gas-cooler-outlet conditions can be controlled by regulating the compressor discharge pressure, i.e. the refrigerant pressure at the gas-cooler outlet, the refrigerant pressure at the gas-cooler outlet is increased to secure sufficient cooling capacity or enthalpy difference during the summer months where the outside-air temperature is higher.

Specifically, the cooling cycle using fluorocarbon refrigerant has 0.2-1.6 Mpa refrigerant pressure in the cycle, whereas the cooling cycle using CO₂ refrigerant has 3.5-10.0 Mpa refrigerant pressure in the cycle, which is remarkably higher than in the fluorocarbon cooling cycle.

An attempt has been made in the cooling cycle using supercritical refrigerant to enhance the ratio of the cooling capacity of an evaporator to the workload of a compressor, i.e. coefficient of performance (COP). U.S. Pat. No. 5,245,836 issued Sep. 21, 1993 to Lorentzen, et al. proposes enhancement in COP by carrying out heat exchange between refrigerant that has passed through the evaporator and supercritical-area refrigerant that is present in a high-pressure line. In the cooling cycle including such internal heat exchanger, refrigerant is further cooled by the heat exchanger to reach a throttling valve. This leads to still lower temperature of refrigerant at the inlet of the throttling valve, which provides maximum COP.

Even in the cooling cycle including such internal heat exchanger, when the cooling cycle is in the high-load state where the outside-air temperature is higher than, for example, 30° C., and the vehicle is at a standstill where the velocity of cooling air for the gas cooler is low, the radiation performance of the gas cooler is remarkably degraded. As a result, the temperature of refrigerant at the gas-cooler outlet is not sufficiently lowered, thus degrading the cooling performance of the evaporator.

### SUMMARY OF THE INVENTION

It is, therefore, an object of the present invention to provide a cooling cycle which can provide sufficient cooling performance even when the radiation effect of the gas cooler is lower.

The present invention provides generally a cooling cycle, which comprises: a compressor that compresses a refrigerant; a gas cooler that cools the compressed refrigerant; a throttling device that throttles flow of the cooled refrigerant; an evaporator that cools intake air by a heat absorbing action of the cooled refrigerant; and a heat exchanger arranged between the compressor and the throttling device, the heat exchanger carrying out heat exchange through the compressed refrigerant.

### BRIEF DESCRIPTION OF THE DRAWINGS

The other objects and features of the present invention will become apparent from the following description with reference to the attached drawings, wherein:

FIG. 1 is a circuit diagram showing a first embodiment of a control cycle for use in automotive air-conditioning systems according to the present invention;

FIG. 2 is a diagram similar to FIG. 1, showing a second embodiment of the present invention;

FIG. 3 is a front view showing an example of a radiator used in the second embodiment;

FIG. 4 is a plan view showing the radiator in FIG. 3;

FIG. 5 is a view similar to FIG. 3, showing another example of the radiator used in the second embodiment;

FIG. 6 is a cross section taken along the line VI-VI in FIG. 5; and

FIG. 7 is a Mollier diagram for explaining the cooling cycle of CO₂ refrigerant;

### DETAILED DESCRIPTION OF THE INVENTION

Referring to the drawings, a description is made with regard to preferred embodiments of the cooling cycle according to the present invention.

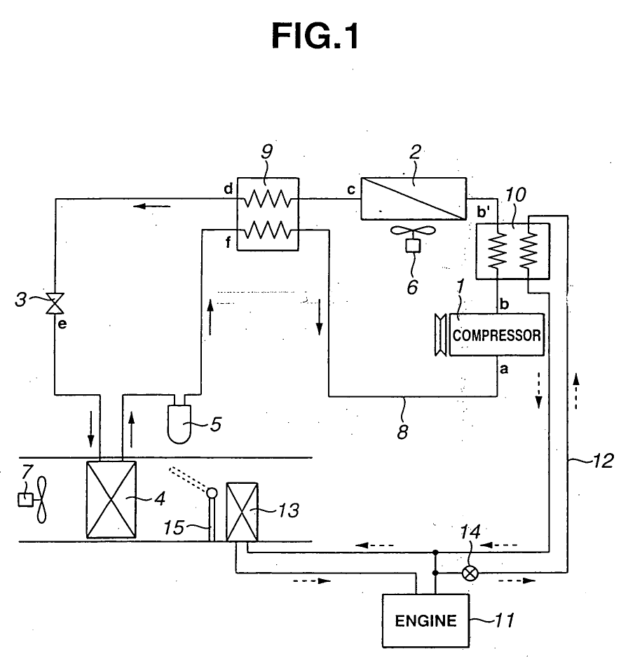

Referring to FIG. 1, the cooling cycle comprises a compressor 1, a heat exchanger 10 (second exchanger), a gas cooler 2, an internal heat exchanger 9 (first heat exchanger), a pressure control valve or throttling means 3, an evaporator or heat sink 4, and a trap or accumulator 5, which are connected in this order by a refrigerant line 8 to form a closed circuit.

The compressor 1 is driven by a prime mover such as engine or motor to compress a CO₂ refrigerant in the gaseous phase and discharge the high-temperature high-pressure refrigerant to the gas cooler 2. The compressor 1 may be of any type such as variable-displacement type wherein automatic control of the discharge quantity and pressure of refrigerant is carried out internally or externally in accordance with the conditions of refrigerant in a cooling cycle, constant-displacement type with rotational-speed control capability or the like.

The heat exchanger 10 carries out heat exchange between the high-temperature high-pressure refrigerant discharged from the compressor 1 and a coolant or cooling water of an engine or automotive prime mover 11. The coolant is provided by a water pump, not shown, to the heat exchanger 10 through a coolant line 12, which is led to a heater core or heating device 13 arranged in the vehicle cabin, then returned to the engine 11. Note that the direction of flow of the coolant is shown by dotted arrow in FIG. 1. An open/close valve 14 is arranged in the coolant line 12 in the vicinity of the outlet of the engine 11. When it is necessary to provide the coolant to the heat exchanger 10, the open/close valve 14 is opened, whereas when it is not necessary, the valve 14 is closed to lead the coolant to the heater core 13 directly. The coolant is provided to a radiator, not shown, arranged at the front of the vehicle through another line, wherein its temperature is reduced to an optimum value for cooling of the engine 11.

The gas cooler 2 carries out heat exchange between the high-temperature high-pressure CO₂ refrigerant compressed by the compressor 1 and subjected to passage through the heat exchanger 10 and the outside air or the like for cooling of the refrigerant. The gas cooler 2 is provided with a cooling fan 6 for allowing acceleration of heat exchange or implementation thereof even when the vehicle is at a standstill. In order to cool the refrigerant within the gas cooler 2 up to the outside-air temperature as closely as possible, the gas cooler 2 is arranged at the front of the vehicle, for example.

The internal heat exchanger 9 carries out heat exchange between the CO₂ refrigerant flowing from the gas cooler 2 and the refrigerant flowing from the trap 5. During operation, heat is dissipated from the former refrigerant to the latter refrigerant.

The pressure control valve or pressure-reducing valve 3 reduces the pressure of CO₂ refrigerant by making the high-pressure (about 10 Mpa) refrigerant flowing from the internal heat exchanger 9 pass through a pressure-reducing hole. The pressure control valve 3 caries out not only pressure reduction of the refrigerant, but pressure control thereof at the outlet of the gas cooler 2. The refrigerant with the pressure reduced by the pressure control valve 3, which is in the two-phase (gas-liquid) state, flows into the evaporator 4. The pressure control valve 3 may be of any type such as duty-ratio control type wherein the opening/closing duty ratio of the pressure-reducing hole is controlled by an electric signal, etc.

The evaporator 4 is accommodated in a casing of an automotive air-conditioning unit, for example, to provide cooling for air vented into the vehicle cabin. Air taken in from the outside or the cabin by a fan 7 is cooled by the passage through the evaporator 4, which is discharged from a vent, not shown, to a desired position in the cabin. Specifically, when evaporating or vaporizing in the evaporator 4, the two-phase CO₂ refrigerant flowing from the pressure control valve 3 absorbs latent heat of vaporization from introduced air for cooling thereof. The heater core 13 is arranged downstream of the evaporator 4, at the front of which an air mixing door 15 is arranged rotatably. When heating intake air, the air mixing door 15 is rotated in a position shown by broken line in FIG. 1, whereas when carrying out no heating, it is rotated in a position shown by solid line in FIG. 1.

The trap 5 separates the CO₂ refrigerant that has passed through the evaporator 4 into a gaseous-phase portion and a liquid-phase portion. Only the gaseous-phase portion is returned to the compressor 1, and the liquid-phase portion is temporarily accumulated in the trap 5.

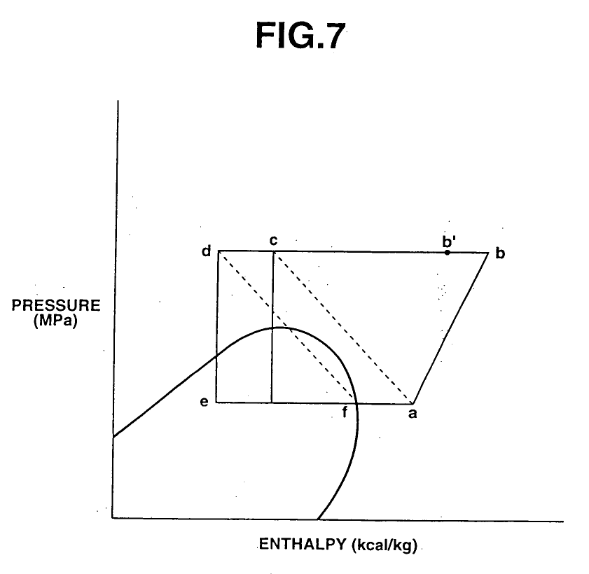

Referring to FIG. 7, the operation of the cooling cycle is described. A gaseous-phase CO₂ refrigerant is compressed by the compressor 1(a-b). The high-temperature high-pressure gaseous-phase refrigerant is cooled by the heat exchanger 10 (b-b′). The temperature of the refrigerant is about 140° C. at the outlet “b” of the compressor 1, while the temperature of the coolant provided from the engine 11 to the heat exchanger 10 is 95° C. at maximum. Thus, the refrigerant is cooled to about 130° C. by the passage through the heat exchanger 10.

The refrigerant precooled by the heat exchanger 10 is cooled further by the gas cooler 2(c-d). Then, the refrigerant is reduced in pressure by the pressure control valve 3(d-e), which makes the refrigerant fall in the two-phase (gas-liquid) state. The two-phase refrigerant is evaporated in the evaporator 4(e-f) to absorb latent heat of vaporization from introduced air for cooling thereof. Such operation of the cooling cycle allows cooling of air introduced in the air-conditioning unit, which is vented into the cabin for cooling thereof.

In the trap 5, the refrigerant that has passed through the evaporator 4 is separated into a gaseous-phase portion and a liquid-phase portion. Only the gaseous-phase portion passes through the internal heat exchanger 9 to absorb heat (f-a), and is inputted again to the compressor 1.

In such a way, the heat exchanger 10 is arranged at the outlet of the compressor 1 to precool the high-temperature refrigerant to be provided to the gas cooler 2. Thus, even when the cooling capacity of the gas cooler 2 is degraded temporarily due to higher outside-air temperature and vehicle standstill, the refrigerant that has passed through the gas cooler 2 is sufficiently low in temperature, allowing preservation of the cooling capacity of the evaporator 4.

On the other hand, fulfillment of sufficient heating capacity is desired due to lower outside-air temperature, the air mixing door 15 arranged in front of the heater core 13 is rotated in the position shown by broken line in FIG. 1. During normal heating, there is no need to precool the refrigerant by supplying the coolant, whereas when quick heating is desired, the open/close valve 14 is opened to circulate the coolant to the heat exchanger 10, starting the cooling cycle. With this, the low-temperature coolant provided to the heat exchanger 10 absorbs heat from the high-temperature refrigerant to become high-temperature coolant, which is supplied to the heater core 13. Therefore, even when the temperature of the coolant is not high enough to carry out heating, quick dehumidifying heating can be achieved due to heating by the heat exchanger 10.

In the first embodiment, the heat exchanger 10 is arranged in the refrigerant line 8 at the position between the compressor 1 and the gas cooler 2. Optionally, when a space for the heat exchanger 10 is difficult to secure in the engine room, it is recommended to adopt the following embodiment.

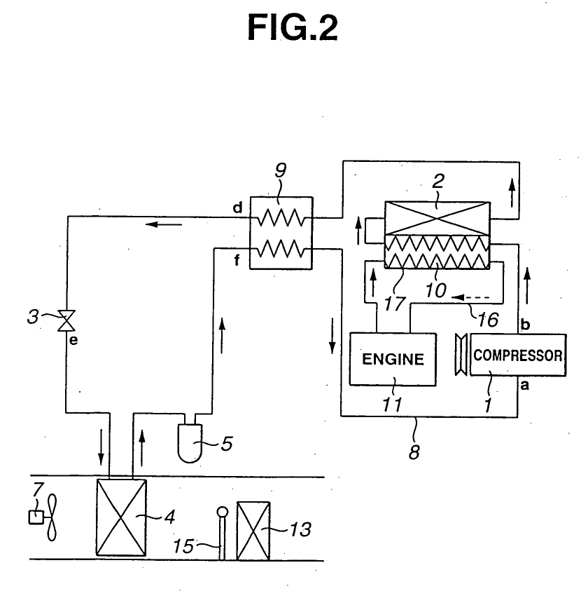

Specifically, in the second embodiment, referring to FIG. 2, the heat exchanger 10 for carrying out heat exchange between the refrigerant at the outlet of the compressor 1 and the coolant of the engine 11 is integrated with an automotive radiator 17. Specifically, the gas cooler 2 and the radiator 17 are disposed adjacently at the front of the vehicle. In ordinary cases, the gas cooler 2 is disposed in front of the radiator 17. The coolant is provided to the radiator 17 by a water pump, not shown, wherein its temperature is reduced to an optimum value for cooling of the engine 11. Then, the coolant is returned to the engine 11. As is not shown, another line is arranged for the coolant to be provided to the heater core 13.

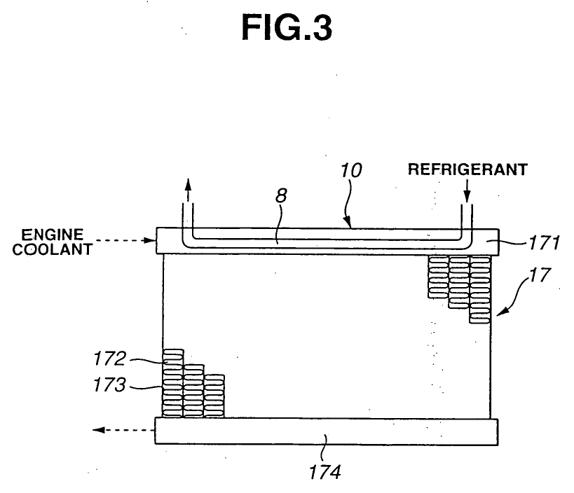

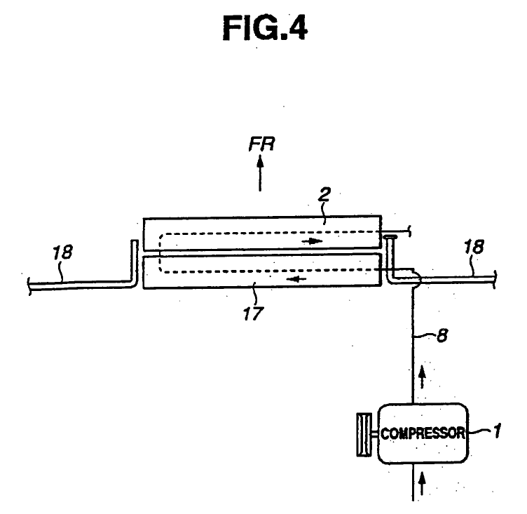

Referring to FIGS. 3-4, there is shown an example of the radiator 17 which comprises an upper tank 171 to which the coolant is provided from the engine 11, a plurality of radiating tubes 172 through which the coolant in the upper tank 171 flows down, a plurality of radiating fins 173 arranged between the tubes 172, and a lower tank 174 into which the coolant after the passage through the tubes 172 is accumulated for return to the engine 11. Air out of the cooling fan 6 and that resulting from cruising pass through spaces between the tubes 172 and the fins 173, cooling the coolant flowing down through the tubes 172.

In this embodiment, the heat exchanger 10 is constructed by arranging the refrigerant line 8 between the compressor 1 and the gas cooler 2 through the upper tank 171 of the radiator 17, i.e. it is of the double-tube structure having the refrigerant line 8 arranged inside the upper tank 171. The heat exchanger 10 may be constructed by arranging the refrigerant line 8 through the lower tank 174. However, arrangement in the upper tank 171, i.e. at the inlet of the radiator 17 is preferable to arrangement in the lower tank 174, i.e. at the outlet of the radiator 17 in view of easy control of the coolant at an optimum temperature. Note that the present invention is applicable to the cooling cycle having the heat exchanger 10 arranged at the outlet of the radiator 17.

In view of the efficiency of heat exchange, it is preferable to oppose the direction of the coolant flowing into the upper tank 171 to that of the refrigerant flowing down therein, i.e. to form counter flow. Note that the present invention is applicable not only to the cooling cycle having counter flow, but the cooling cycle having forward flow.

Referring to FIG. 4, numeral 18 designates a radiator-core panel of a vehicle body. In this embodiment, the heat exchanger 10 is constructed by arranging the refrigerant line 8 through the upper tank 171 of the radiator 17. This not only prevents taking-up of a space in the engine room, but allows a piping path of the refrigerant line 8 as shown in FIG. 4, the refrigerant line 8 crosses over the radiator panel 18 only once. Specifically, with the earlier-art gas cooler 2, the refrigerant line 8 crosses on the inlet side over the left radiator-core panel 18 for connection to the gas cooler 2, then on the outlet side the right radiator-core panel 18. This leads to problems of difficult securing of a piping space for the refrigerant line 8 and increasing of the length of the refrigerant line 8. On the other hand, in this embodiment, the gas cooler 2 produces an auxiliary effect that the refrigerant line 8 can be arranged in a short path.

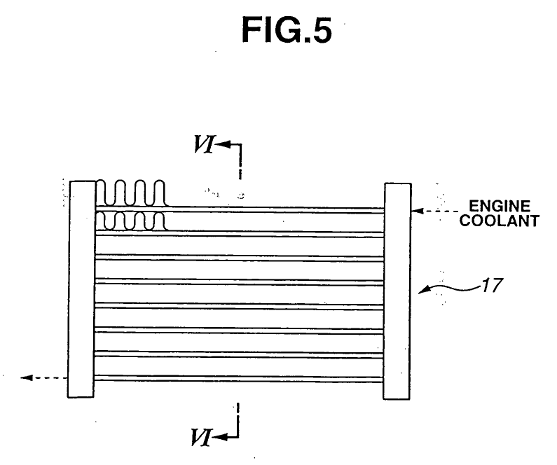

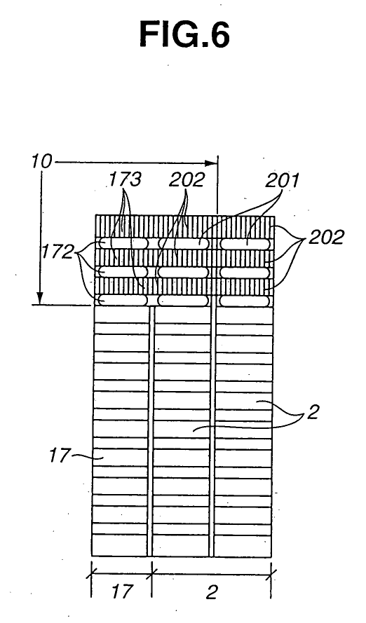

Referring to FIGS. 5-6, there are shown another example of the radiator 17 and the gas cooler 2 (which is not seen in FIG. 5 as being located behind the radiator 17). The radiator 17 and the gas cooler 2 both include right and left tanks. Note that the radiator 17 shown in FIG. 3 may include right and left tanks, and the radiator 17 shown in FIG. 5 may include upper and lower tanks.

As shown in FIG. 6, the radiator 17 and the gas cooler 2 are constructed such that the tubes 172 of the radiator 17 for circulation of the coolant and tubes 201 of the gas cooler 2 for circulation of the refrigerant are arranged in the same row. The radiating fins 173, 202 interposed between the respective tubes 172, 201 are also arranged in the same row. Specifically, the tubes 172, 201 of the radiator 17 and gas cooler 2 are arranged at the same pitch. The tubes 172, 201 in three rows and two lines from the upper left in FIG. 6 are connected to radiating fins 173, 202 (which are actually in the form of a series of radiation fins). The other radiating fins 173, 202 are insulated thermally. With this, a portion of the radiator 17 and gas cooler 2 in three rows and two lines from the upper left constitutes heat exchanger 10 of the present invention, wherein heat exchange is carried out between the coolant circulating through the tubes 172 of the radiator 17 and the refrigerant circulating through the tubes 201 of the gas cooler 2. In the other portions of the radiator 17 and gas cooler 2 (including the tubes 201 of the gas cooler 2 in the three rows of the upper right line) the coolant in the radiator 17 and the refrigerant in the gas cooler 2 are cooled by air, respectively.

Having described the present invention in connection with the preferred embodiments, it is to be understood that the present invention is not limited thereto, and various changes and modifications can be made without departing from the scope of the present invention.

By way of example, in the illustrative embodiments, the heat exchanger 10 is arranged between the compressor 1 and gas cooler 2. Alternatively, the heat exchanger 10 may be arranged between the compressor 1 and the pressure control valve 3. Moreover, in the illustrative embodiments, the pressure control valve 3 is of the electric type. Alternatively, the pressure control valve 3 may be of the mechanical expansion type wherein the valve opening degree is adjusted by detecting the pressure and temperature of the high-pressure side refrigerant. In this alternative, a high-pressure side refrigerant pressure detecting part and a high-pressure side refrigerant temperature detecting part are arranged to ensure communication between a valve main body and the gas cooler 2 and internal heat exchanger 9. Further, the internal heat exchanger 9, which is arranged in the illustrative embodiments, can be eliminated if required. Furthermore, the coolant may be a coolant for a drive motor for electric vehicles or a coolant for a generating unit for fuel cell powered vehicles.

As described above, according to the present invention, the heat exchanger is arranged between the compressor and the pressure control valve for carrying out heat exchange through the refrigerant. With this, the temperature of the refrigerant provided to the gas cooler is reduced in advance, so that even when the radiation effect of the gas cooler is low, the temperature of the refrigerant at the outlet of the gas cooler is lowered relatively, resulting in securing of the cooling performance of the evaporator.

Moreover, according to the present invention, the heat exchanger is constructed to allow circulation of an engine coolant therethrough. Since the engine-coolant system is indispensable for the vehicle, the requirement is only extension of its line without any arrangement of additional cooling means, having an advantage in terms of manufacturing cost and space. Further, at engine start, the engine coolant is heated by the high-temperature refrigerant at the outlet of the compressor, contributing to shortening of an engine worm up time.

Furthermore, according to the present invention, the heat exchanger is integrated with an automotive radiator. This allows arrangement of the heat exchanger with practically no taking-up of a space in the engine room.

What is claimed is:

1. A cooling cycle system of a motor vehicle powered by an engine that is configured to be cooled by a coolant flowing through a radiator, the cooling cycle system comprising:
a compressor that is configured to compress a refrigerant;
a gas cooler that is configured to cool the compressed refrigerant;
a throttling device that is configured to throttle flow of the cooled refrigerant;
an evaporator that is configured to cool an intake air by a heat absorbing action of the cooled refrigerant; and
a heat exchanger being provided downstream of the compressor and being integrated with a radiator and with the gas cooler,
wherein the heat exchanger comprises tubes in which coolant is configured to flow and tubes in which the compressed refrigerant is configured to flow,
wherein heat exchange is configured to occur between the coolant and the compressed refrigerant flowing through some of the tubes through which the coolant and the compressed refrigerant flow by means of fins that connect such tubes, and
wherein the coolant and the compressed refrigerant flowing through the remaining tubes are configured to be air cooled.

2. The cooling cycle system as claimed in claim 1, further comprising:
a second heat exchanger that is configured to conduct heat exchange between the refrigerant that flows from: (a) the gas cooler to the throttle device; and (b) the evaporator to the compressor.

3. The cooling cycle system as claimed in claim 2, further comprising:
an accumulator that is arranged in a refrigerant line from the evaporator to the second heat exchanger.

4. The cooling cycle system as claimed in claim 1, wherein the coolant is supplied to a heater core for heating the intake air that is cooled by the evaporator.

5. The cooling cycle system as claimed in claim 1, wherein the gas cooler is provided with a cooling fan for accelerating the heat exchange of the gas cooler.
